(19) United States
(12) Patent Application Publication
(10) Pub. No.: US 2021/0102555 A1
(43) Pub. Date: Apr. 8, 2021

(54) ELECTRIC WATER PUMP

(71) Applicant: Brose Fahrzeugtrile GmbH & Co. Kommanditgesellschaft, Würzburg, Wurzburg (DE)

(72) Inventors: Karl KRUG, Clawson, MI (US); Joseph SURIANO, Grand Blanc, MI (US); Lyle WARD, Royal Oak, MI (US); Matthew DISSETTE, Washington Township, MI (US); Muhash SANJOFY, Canton, MI (US)

(73) Assignee: Brose Fahrzeugteile GmbH & Co. Kommanditgesellschaft, Würzburg, Würzburg (DE)

(21) Appl. No.: 16/592,466

(22) Filed: Oct. 3, 2019

(51) Int. Cl. F04D 29/58; F04D 1/00; F04D 13/06; H02K 7/14

(52) U.S. Cl. CPC F04D 29/5813; F04D 1/00; F05B 2260/2241; F04D 29/588; H02K 7/14; F04D 13/06

(57) ABSTRACT

An electric water pump provided with a housing that includes a cover. The cover may extend from the sidewall and may be fixed to the volute. The cover may include a main portion, a first protrusion, extending from a first side of the main portion towards the impeller, and a second protrusion extending from a second side of the main portion, opposite the first side, towards the base member. The first and second protrusions may define a first aperture. The second protrusion may define a second aperture that may form a first communication passage. The first communication passage may be configured to receive a portion of the first flow of fluid from a first space, disposed between the impeller and the cover, and expel the same to towards the base member.

### TECHNICAL FIELD

The present disclosure relates to a relates to an electromotive water pump, such as a centrifugal or radial pump for a motor vehicle cooling system.

### BACKGROUND

Water pumps can be generally categorized into bypass pumps and main pumps. A main power pump is primarily used for cooling the internal combustion engine of a motor vehicle. Conventional water pumps are typically driven by the fan belt of the engine. Such pumps are therefore coupled directly to the engine speed of the internal combustion engine, which may lead to an uneven cooling of the engine in certain operating situations of the vehicle.

Electric water pumps may be electronically controlled by electronics and a controller and driven by an electric motor that is configured to drive an impeller. Electric water pumps may be used in lieu of a conventional water pump and reduce emissions from the internal combustion engine.

### SUMMARY

According to one embodiment, an electric water pump for use in a vehicle is provided. The electric water pump may include a volute, provided with a suction side configured to receive a first flow of fluid, and a pressure side configured to expel a second flow of fluid. The electric water pump may also include a housing, a rotor, a stator, a heat sink, and a hollow shaft. The housing may include sidewalls that may extend between a cover and an end cap. The hollow shaft may be fixed to the rotor and an impeller and may include a first end, fixed to the impeller, and a second end that may be spaced apart from the heat sink. The cover may extend from the sidewall and may be fixed to the volute. The cover may include a main portion, a first protrusion, extending from a first side of the main portion towards the impeller, and a second protrusion extending from a second side of the main portion, opposite the first side, towards the base member. The first and second protrusions may define a first aperture. The second protrusion may define a second aperture that may form a first communication passage. The first communication passage may be configured to receive a portion of the first flow of fluid from a first space, disposed between the impeller and the cover, and expel the same to towards the base member.

According to another embodiment, an electric water pump for use in a vehicle is provided. The electric water pump may include a volute, provided with a suction side configured to receive a first flow of fluid, and a pressure side configured to expel a second flow of fluid. The electric water pump may also include a housing, a rotor, a stator, a heat sink, and a hollow shaft. The housing may include sidewalls that may extend between a cover and an end cap. The hollow shaft may include a first end, that may be fixed to the impeller, and a second end that may be spaced apart from the heat sink. A first communication passage may be formed between the rotor and the stator and configured to receive a portion of the first flow of fluid from a first space, disposed between the impeller and the cover. The heat sink may extend between portions of the sidewall and include a main portion and a first protrusion that may extend from the main portion towards the impeller. The first protrusion may define a first receptacle, a second receptacle, and a first aperture. The first receptacle may receive a portion of the shaft. The first aperture may extend radially between the first receptacle and the second receptacle. The first aperture may form a second communication passage configured to receive the portion of the first flow of fluid from the first communication passage.

According to yet another embodiment, an electric water pump for use in a vehicle is provided. The electric water pump may include a volute, provided with a suction side configured to receive a first flow of fluid, and a pressure side configured to expel a second flow of fluid. The electric water pump may also include an impeller, a housing, a rotor, a stator, a heat sink, and a hollow shaft. The impeller may be disposed between the volute and the cover. The rotor may be disposed within the housing and stator may be disposed between the sidewalls of the housing and the rotor. The housing may include sidewalls that may extend between a cover and an end cap. The cover may include a main portion, a first protrusion, extending from a first side of the main portion towards the impeller, and a second protrusion extending from a second side of the main portion, opposite the first side, towards the heat sink. The first and second protrusions may define a first aperture. The second protrusion may define a second aperture that may form a first communication passage. The first communication passage may be configured to receive a portion of the first flow of fluid from a first space, disposed between the impeller and the cover, and expel the same to towards the base member. The heat sink may extend between portions of the sidewall and include a main portion and a third protrusion that may extend from the main portion towards the impeller. The third protrusion may define a first receptacle, a second receptacle, and a third aperture. The first receptacle may receive a portion of the shaft. The third aperture may extend radially between the first receptacle and the second receptacle. The third aperture may form a second communication passage configured to receive the portion of the first flow of fluid from at least one of the communication passages.

### BRIEF DESCRIPTION OF THE DRAWINGS

FIG. 1 is a perspective view of an exemplary electric water pump assembly.

FIG. 2 is a cross-sectional view of the exemplary electric water pump assembly in FIG. 1.

FIG. 3 is partial-cross-sectional view of the exemplary electric water pump assembly.

FIG. 4 is a perspective view of an exemplary heat sink of the electric water pump.

FIG. 5 is a perspective view of a first side of an exemplary motor housing.

FIG. 6 is a perspective view of a second side of the exemplary motor housing.

FIG. 7 is a detail perspective view of a protrusion of the exemplary motor housing illustrated in FIG. 6.

FIG. 8 is a perspective view of a bushing of the exemplary electric water pump assembly.

FIG. 9 is a perspective view of another bushing of the exemplary electric water pump assembly.

FIG. 10 is an exploded view of an exemplary rotor of the electric water pump assembly.

FIG. 11 is a partial-cross sectional view of a prior-art water pump.

FIG. 12 is a partial-cross sectional view of the water pump assembly according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This invention is not limited to the specific embodiments and methods described below, as specific components and/or conditions may, of course, vary. Furthermore, the terminology used herein is used only for the purpose of describing particular embodiments of the present invention and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “about” may be used herein to describe disclosed or claimed embodiments. The term “substantially” or “about” may modify a value or relative characteristic disclosed or claimed in the present disclosure. In such instances, “substantially” or “about” may signify that the value or relative characteristic it modifies is within ±0%, 0.1%, 0.5%, 1%, 2%, 3%, 4%, 5% or 10% of the value or relative characteristic.

The term “radial” or “radially” may be used herein to describe disclosed or claimed embodiments. The term “radial” or “radially” may signify a direction that is substantially orthogonal to a rotational axis of a shaft of the electric water pump.

The term “axial” or “axially” may be used herein to describe disclosed or claimed embodiments. The term “axial” or “axially” may signify a direction that is substantially parallel to or in line with a rotational axis of a shaft of the electric water pump.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). The term “and/or” includes any and all combinations of one or more of the associated listed items.

Although the terms first, second, third, etc. may be used to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Referring generally to the figures, an electric water pump 100 for use in a vehicle is provided. The water pump 100 may include a volute 102 provided with a suction port 104 and a pressure port 106. The suction port 104 may be configured to receive a first flow of fluid, from a vehicle coolant system (not illustrated). The pressure port 106 may be configured to expel a second flow of fluid to one or more vehicle components, including but not limited to an engine, electric motor, a heat exchanger, or some combination thereof. The volute 102 may be fixed to a housing 108 that may include one or more sidewalls 110 that may extend between a cover 112 and an end cap 114.

The cover 112 may include a main portion 132, a first protrusion 134, and a second protrusion 136. The first protrusion 134 may extend from a first side 135 of the main portion 132 and the second protrusion 136 may extend from a second side 138 of the main portion 132, that is opposite the first side 135. The first protrusion 134 and the second protrusion 136 may each define a shaft aperture 140 that may receive a portion of the hollow shaft 124. A first communication passage 142 may be formed by an aperture 144 defined by the second protrusion 136. The first communication passage 142 may be configured to receive a portion of fluid from a first space 146 that may be disposed between the impeller 126 and the cover 112 and expel the same towards the heat sink 122. As one example, the impeller 126 and the cover 112 may form a high-pressure area 196 and a low-pressure area 198. The high-pressure area 196 may be formed by an area that is disposed radially outside of the impeller 126 and the low-pressure area 198 may be formed by an area disposed radially inward of outer portions of the impeller 126. The first space 146 may be disposed in the low-pressure area 198 defined by the cover 112 and the impeller 126.

The second protrusion 136 may include a wall 176 that may extend radially from the shaft aperture 140. The wall 176 may include one or more pockets 178 that may extend radially from the shaft aperture 140. One or more of the pockets 178 may include recessed portions that include an aperture 144 that that forms the first communication passage 142. As one example, the pockets 178 may include an inner portion and an outer portion. The inner portions of the pockets 178 may have a first width W1 and the outer portions may have a second width W2 that may be greater than the first width W1.

The electric water pump 100 may include a number of electronics, such as a printed circuit board 125 that may be configured to receive and send signals to control operating parameters of the electric water pump 100. The printed circuit board 125 may be disposed between the heat sink 122 and the end cap 114. The end cap 114 may extend between portions of the sidewall 110.

An electric motor 116 may be disposed in the housing and include a rotor 118 and a stator 120 that may be disposed between the rotor 118 and the sidewall 110. A second communication passage 121 may be formed between the rotor 118 and the stator 120. A base member, such as a heat sink 122, may be disposed between the end cap 114 and the rotor 118. The heat sink 122 may be configured to absorb excessive or unwanted heat generated by electronics, such as a printed circuit board 125 disposed between the end cap 114 and the heat sink 122. The rotor 118 and an impeller 126 may each be mounted to a shaft, such as a hollow shaft 124, that may include a first end 128 and a second end 130. The first end 128 of the hollow shaft 124 may be fixed to the impeller 126 and the second end 130 of the hollow shaft 124 may be spaced apart from a portion of the heat sink 122.

The heat sink 122 may include a third protrusion 148 that may extend towards the impeller 126. The third protrusion 148 may define a first receptacle 150, a second receptacle 152, and an aperture 154. The first receptacle 150 may receive a portion of the hollow shaft 124 such that the hollow shaft 124 is rotatable with respect to the first receptacle 150 of the heat sink 122. The aperture 154 may extend radially between the first receptacle 150 and the second receptacle 152 to form a third communication passage 160 that may be configured to receive the portion of the first flow of fluid from the second communication passage 121. As one example, the second receptacle 152 may include an inner portion and an outer portion. The inner portion may have a first width W3 and the outer portion may have a second width W4, that may be greater than the first width W3. An inner periphery of the hollow shaft 124 may form a fourth communication passage 162 that may be configured to receive fluid from the first receptacle 150 of the heat sink 122 and expel the same towards the impeller 126.

The hollow shaft 124 may be supported by a number of bushings. For example, a first bushing 164 may be disposed in the shaft aperture 140 and include an aperture 166 that may receive the hollow shaft 124. The first bushing 164 may be fixed to the shaft aperture 140 so that the hollow shaft 124 rotates with respect to the first bushing 164. The aperture 166 of the first bushing 164 and an outer periphery of the hollow shaft 124 may be arranged to form a fifth communication passage 168 that may be configured to receive the portion of the fluid from the first space 146.

A second bushing 170 may be disposed on the hollow shaft and between the first bushing 164 and the rotor 118. The second bushing 170 may be planar member that is configured to rotate with the hollow shaft 124. In one or more embodiments, the first bushing 164 may include a radial wall 172 that may extend in a radial direction from the aperture 166 and contact the second bushing 170. The radial wall 172 and the second bushing 170 may be arranged to form a sixth communication passage 174 that may be configured to receive the portion of the fluid from the fifth communication passage 168.

In one or more embodiments, a third bushing 184 may be disposed in the first receptacle 150 and configured to support the hollow shaft 124. The third bushing 184 may be held stationary in the first receptacle 150 so that the hollow shaft rotates with respect to the third bushing 184.

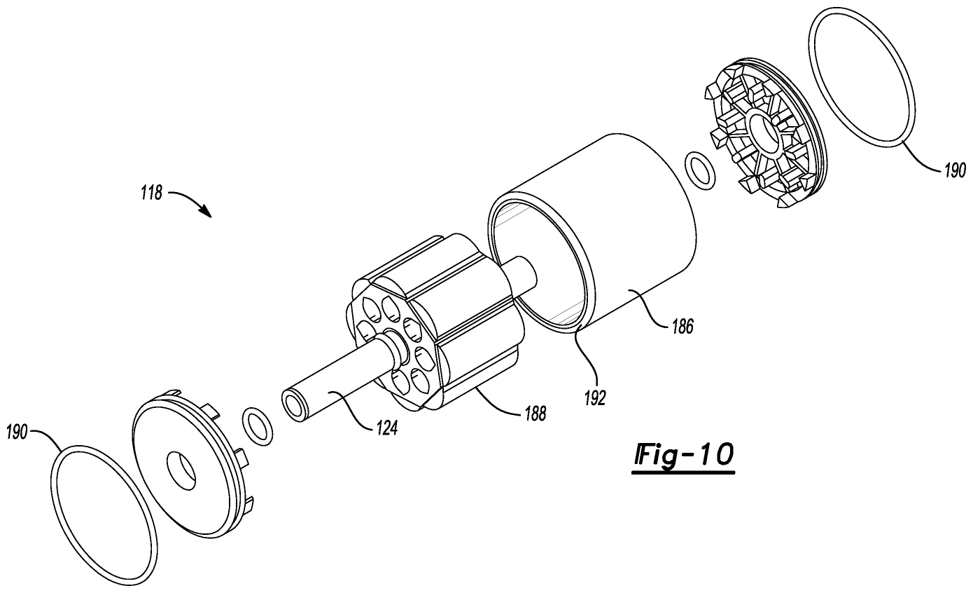

Referring specifically to FIG. 10, a perspective-exploded view of the rotor 118 is illustrated. The rotor 118 may be water proof or substantially water resistant as defined by Underwriters Laboratories. For example, the rotor may comply with standards set under UL NEMA Type 3, Type 3R, or both. The rotor 118 may provide a compartment formed by a sleeve 186 that receives a stack of laminations 188. A pair of rings 190 may be provided to enclose the stack of laminations 188 and engage portions of the sleeve 186. A first end 192 of the sleeve 186 may be bent over one of the rings 190 to form a radius R1. The first radius R1 may be configured to deflect fluid towards the second communication passage 121 from the fifth communication passage 168 and the sixth communication passage 174. A second end 194 of the sleeve 186 may be bent over the second ring 190 to form a second radius R2. As one example, bending the second end 194 of the sleeve over the second ring 190 may form a bulbous portion or section that may be spaced apart from a corner of the stack of laminations 188. The second radius R2 may be configured to deflect fluid from the second communication passage 121 to the heat sink 122 and the third bushing 184.

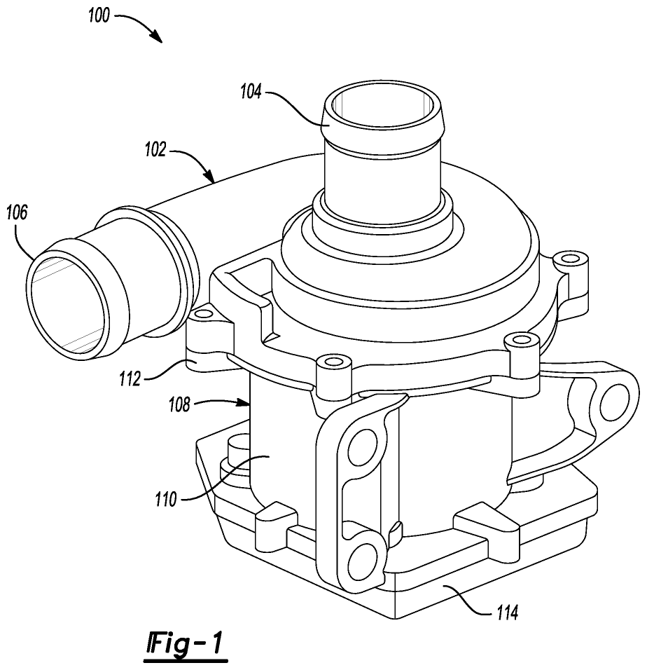

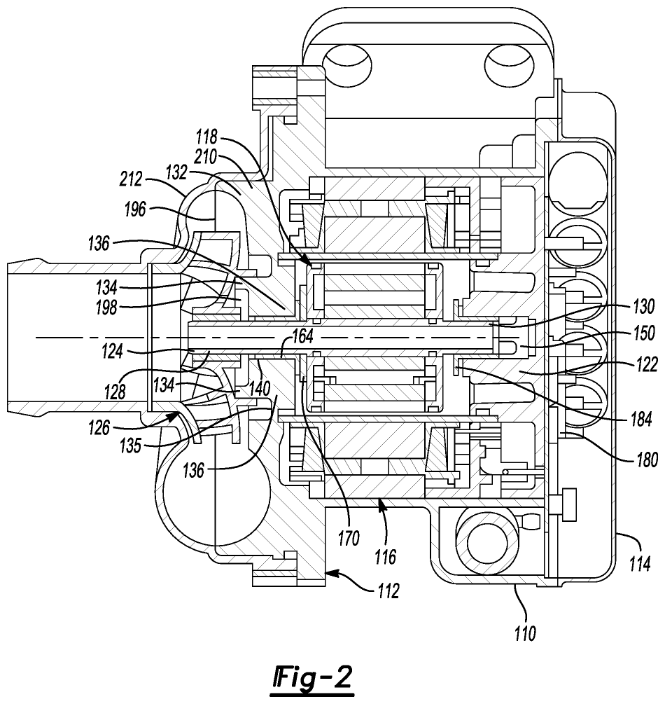

FIG. 1 illustrates a perspective view of an exemplary water pump assembly 100 according to one or more embodiments of the present disclosure and FIG. 2 illustrates a cross-sectional view of the exemplary water pump assembly 100. The volute 102 of the water pump 100 may include the suction port 104 or inlet and a pressure port 106, such as an outlet. As will be described in greater detailed below, the volute 102 may be coupled to the cover 112 of the motor housing 108 by one or more methods. The impeller 126 may be sandwiched between the volute 102 and the cover 112. The impeller 126 may include a shroud 200, a hub 202, and a number of blades 204 that may extend between the shroud 200 and the hub 202. As the impeller 126 rotates, the blades 204 may displace fluid, such as coolant or water, to expel the fluid through the outlet 106. A labyrinth 208 may extend axially from the hub towards the rotor 118. The labyrinth 208 may be configured to rotate along a portion of the first protrusion 134.

Outer portions 210 of the cover 112 in combination with outer portions 212 of the volute 102 (FIG. 2) may form the high-pressure area 196. The outer portions 210 of the cover 112 and the outer portions 212 of the volute 102 may each include recessed portions that may define the high-pressure area 196. The low-pressure area 198 may be formed by an inner portion 214 of the cover 112 and the hub 202 of the impeller 126.

The sidewall 110 may extend from the cover 112 in a direction that is substantially parallel to a rotational axis R defined by the hollow shaft 124. The heat sink 122 may extend between and may be attached to the sidewalls 110 by an outer ring 238 to position the heat sink 122 radially. A flange 240 may extend from the outer ring 238 and form one or more apertures 242 that may receive a fastener (not illustrated) to the housing 108. A barrier member, such as a wet-dry separator 216 may extend between the second receptacle 152 and the inner portion 214 of the cover 112. The cover 112, sidewall 110, and the heat sink 122 may define a receptacle or container 218 that may house the rotor 118 and define a portion of a wet area of the water pump 100. The wet area includes the space surrounding the rotor 118 within the container 218 and an area between the volute 102 and the cover 112. The stator 120 may be disposed between the sidewall 110 and the wet-dry separator 216. The stator 120 may include a lamination material and a number of windings (not illustrated) that may be electrically connected to the circuit board 125. When the stator receives current or power, the rotor 118 may be magnetically propelled to rotate about the rotational axis R.

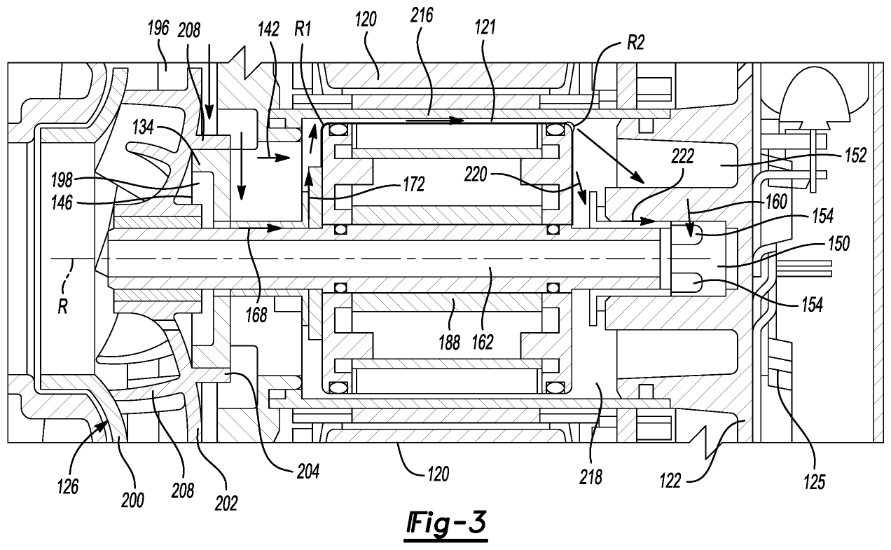

FIG. 3 illustrates a partial-cross-sectional schematic view of the electric water pump 100 and the flow of fluid therein. As mentioned above, portions of the fluid may be received by the first communication passage 142, formed by the aperture 144 of the second protrusion 136, from the low-pressure areas between the hub 202 and inner portions 214 of the cover 112. The second communication passage 121 may be formed between the rotor 118 and the stator 120. As one example, the wet-dry separator 216 and the sleeve 186 of the rotor 118 may form the second communication passage 121. The fifth communication passage 168 may be formed between the aperture 166 of the first bushing 164 and an outer periphery of the hollow shaft 124. The fifth communication passage may communicate fluid in a direction that is parallel to the rotational axis R and may cool or dissipate heat generated between the hollow shaft 124 and the first bushing 164. The sixth communication passage 174 may be formed between the axial wall 172 and the second bushing 170.

The third communication passage 160 may be formed by the aperture 154 that may extend radially between the first receptacle 150 and the second receptacle 152. The third communication passage 160 may be configured to receive fluid from the second communication passage 121. The fourth communication passage 162 may be formed by an inner periphery of the hollow shaft 124 and configured to receive fluid from first receptacle 150 of the heat sink 122 and expel the same to the blades 204 that may move the fluid to the high-pressure area 196. In one or more embodiments, the third bushing 184 may be spaced apart from the rotor 118. The space between the rotor 118 and the third bushing may form a seventh communication passage 220. An eighth communication passage 222 may be formed between the third bushing 184 and the outer periphery of the hollow shaft 124. The eighth communication passage 222 may receive fluid from the seventh communication passage 220 and configured to cool or dissipate heat between the third bushing 184 and the hollow shaft 124. Dissipating heat between the shaft 124 and the bushings may mitigate friction and extend the life or usefulness of the bushings.

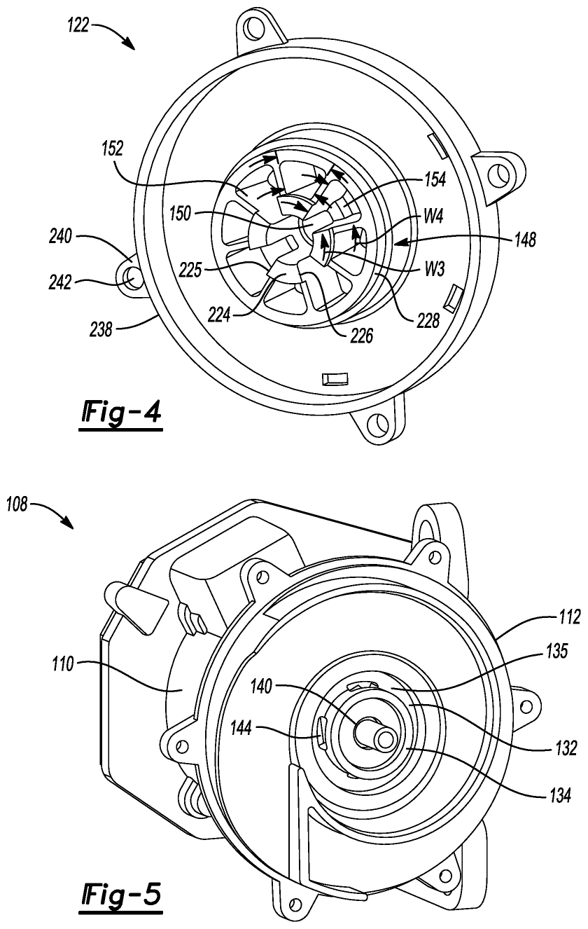

FIG. 4 illustrates a perspective view of the heat sink 122. The heat sink may include the third protrusion 148 that extends towards the impeller. As mentioned above, the third protrusion 148 may define the first receptacle 150 and the second receptacle 152, and the aperture 154 formed therebetween. One or more planar faces 224 may be formed by a distal end 225 of the third protrusion 148. One or more edges 226 of the planar faces 224 may be configured to engage portions of the third bushing 184 so that the third bushing 184 is rotationally fixed with respect to the hollow shaft 124, the heat sink 122, or both. An outer periphery 228 of the distal end 225 may be tapered so that it forms a sealing surface to form a water proof connection.

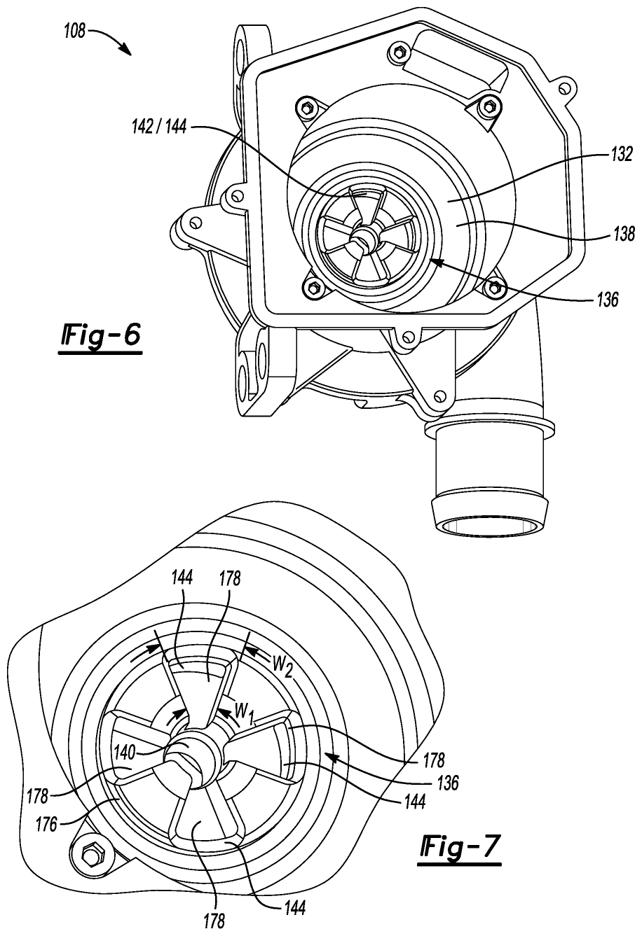

FIG. 5 illustrates a perspective view of a first side of the motor housing 108 without the volute 102. As mentioned above, the cover 112 may extend from the sidewall 110 and include a main portion 132 and a first protrusion 134. The first protrusion 134 may include the shaft aperture 140 that receives the hollow shaft 124. The aperture 144 formed by the second protrusion 136 (FIG. 6) may extend through the main portion 132 from the second protrusion 136.

FIG. 6 illustrates a perspective view of a second side of the motor housing 108. Here, the heat sink 122 and the end cap are not illustrated so an inner portion of the motor housing 108 may be shown. The second protrusion 136 is shown extending from the second side 138 of the main portion 132 of the cover 112. The first communication passage 142 formed by the aperture 144 is formed by a distal end of the second protrusion.

FIG. 7 illustrates a detailed-perspective view of the second protrusion. As mentioned above, the aperture 144 forming the first communication passage 142 may each be disposed in one or more pockets 178. A number of the pockets 178 may be tapered so that an outer portion has a width that may be greater than a width of the inner portions of the pockets 178. One or more second planar faces 230 may be disposed between each of the pockets 178. One or more portions, such as edges 232, of the planar faces 230 may be configured to engage portions of the first bushing 164 so that the first bushing 164 is rotationally fixed with respect to the hollow shaft 124, the cover 112, or both.

FIG. 8 illustrates a perspective view of an exemplary bushing. The bushing illustrated may be the first bushing 164, the third bushing 184, or both. The bushing 164 includes an aperture 166 that receives the hollow shaft. A first end of the bushing may include a chamfer 234 that may facilitate insertion of the first end into a mating component, such as the aperture formed by second protrusion 136 or the third protrusion 148, or both. A second end of the bushing may include a radial wall 172 that extends radially from the body of the bushing that defines the aperture 166. A number of locking features, such as tabs 236 may extend in an axial direction from the radial wall. As another example, the tabs 236 may extend radially from the body of the bushing.

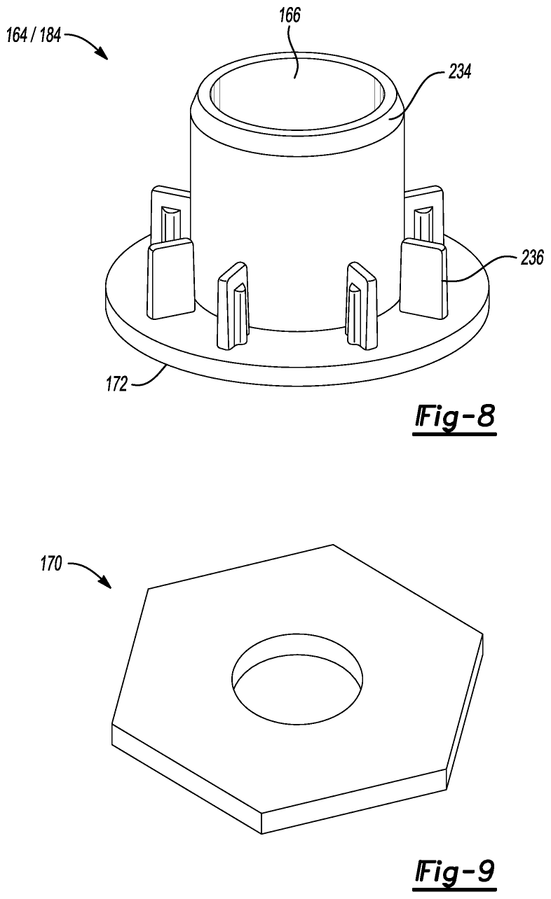

FIG. 9 illustrates a perspective view of the second bushing 170. The second bushing 170 may be a planar member that has a polygonal shape. In one or more embodiments, the second bushing 170 may have a hexagonal shape such that rotation of the rotor and the shaft transfers torque from the rotor to the second bushing.

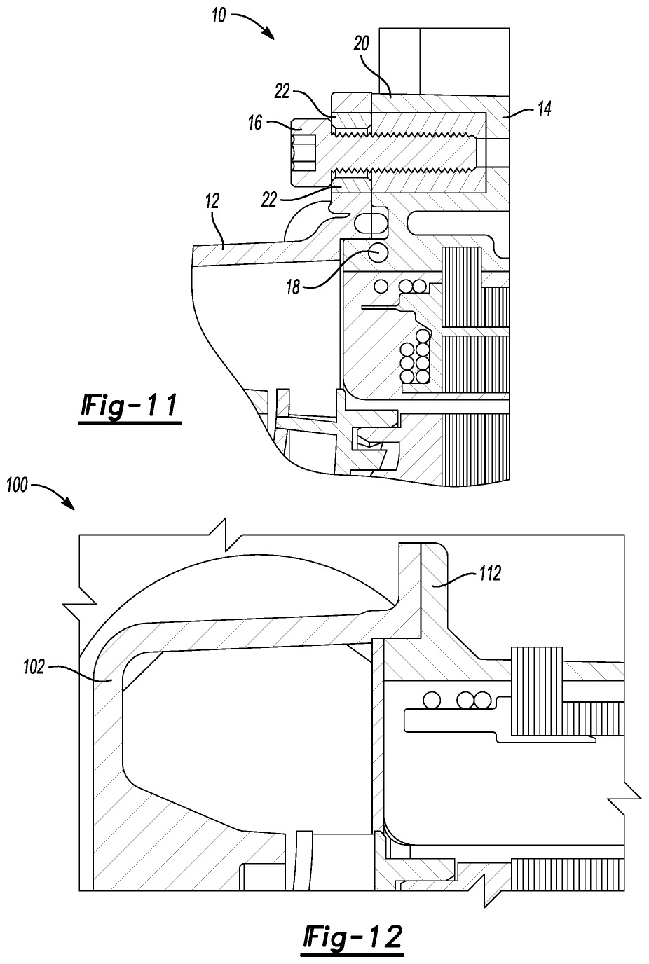

FIG. 11 illustrates partial-cross sectional view of a prior-art water pump 10. More specifically, FIG. 11 illustrates a known configuration for attaching a volute 12 to the motor housing 14. Generally, the volute 12 and the motor housing 14 of the prior-art water pump 10 are each formed by plastic and are attached to one another by a number of threaded fasteners 16. Because fastening does not generally provide a water tight connection this method may require additional sealing by use of an O-ring seal 18. To securely attach the volute 12 to the housing 14, a screw insert 20 formed of a material stronger than the material of the housing 14 is required. To prevent over tightening of the fastener between the volute 12 and the housing 14, a compression limiter 22 configured to absorb excessive clamp loads is required.

FIG. 12 illustrates a partial-cross sectional view of the water pump assembly 100. Here the plastic material of the volute 102 and the cover 112 are joined by one or more laser welding seams. The laser welding seams may be created by laser plastic welding, sometimes referred to as through-transmission welding. Through-transmission welding may include a process of bonding plastic using focused laser radiation. Materials for through-transmission welding may require at least one layer that is laser transparent, such as material that is configured to transmit all or most infrared beams within a predetermined range of wavelengths. As one example, the volute or the housing may be formed of a thermoplastic resin suitable for through-transmission welding. The mating material joined with the laser transparent material may be configured to absorb the remaining laser energy after it has passed through the laser transparent material. As one example, the volute or the housing may be formed of a thermoplastic resin that includes 0.2% to 0.5% of dark colorant such as carbon soot. The volute and the housing may each be formed of one of the following materials PA 6, PA 66, POM, PBT, PC, ABS, PP, TPE and PE.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### PARTS LIST

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.
10 prior-art water pump
12 volute
14 housing
16 threaded fasteners
18 O-ring seal
20 screw insert
22 compression limiter
100 electric water pump
102 volute
104 suction port
106 outlet
108 motor housing
110 sidewall
112 cover
114 end cap
116 electric motor
118 rotor
120 stator
121 second communication passage
122 heat sink
124 hollow shaft
124 shaft
125 circuit board
126 impeller
128 first end
130 second end
132 main portion
134 first protrusion
135 first side
136 second protrusion
138 second side
140 shaft aperture
142 first communication passage
144 aperture
146 first space
148 third protrusion
150 first receptacle
152 second receptacle
154 aperture
160 third communication passage
162 fourth communication passage
164 first bushing
166 aperture
168 fifth communication passage
170 second bushing
172 radial wall
174 sixth communication passage
176 wall
178 pockets
184 third bushing
186 sleeve
188 laminations
190 rings
192 first end
194 second end
196 high-pressure area
198 low-pressure area
200 shroud
202 hub
204 blades
208 labyrinth
210 outer portions
212 outer portions
214 inner portions
216 wet-dry separator
218 container
220 seventh communication passage
222 eighth communication passage
224 planar faces
225 distal end
226 edges
228 outer periphery
230 second planar faces
232 edges
234 chamfer
236 tabs
238 outer ring
240 flange
242 apertures

What is claimed is:

1. An electric water pump for use in a vehicle, the electric water pump comprising:
a volute provided with a suction side, configured to receive a first flow of fluid, and a pressure side configured to expel a second flow of fluid;
an impeller configured to generate move the first flow of fluid and the second flow of fluid;
a sidewall coupled to the volute;
a base member extending between portions of the sidewall, wherein the sidewall and the base member form a container; and
a cover extending from the sidewall and fixed to the volute, wherein the cover includes a main portion, a first protrusion, extending from a first side of the main portion towards the impeller, and a second protrusion extending from a second side of the main portion, opposite the first side, towards the base member, wherein the first and second protrusions define a first aperture, wherein the second protrusion defines a second aperture and forms a first communication passage configured to receive a portion of the first flow of fluid from a first space, disposed between the impeller and the cover, and expel the same to towards the base member.

2. The electric water pump of claim 1, further comprising:
a rotor disposed in the container; and
a hollow shaft fixed to the rotor and the impeller and extending through the first aperture, wherein the hollow shaft includes a first portion, fixed to the impeller, and a second end extending towards the base member, and wherein the hollow shaft forms a second communication passage configured to receive the portion of the first flow of fluid from the base member and to expel the same to the impeller.

3. The electric water pump of claim 2, further comprising a first bushing disposed in the first aperture, wherein the first bushing forms a third aperture that receives the hollow shaft, wherein the third aperture and an outer periphery of the hollow shaft are arranged to form a third communication passage configured to communicate the portion of the first flow of fluid from the first space to a third communication passage formed between a stator and the rotor.

4. The electric water pump of claim 3, further comprising a second bushing disposed on the hollow shaft and between the first bushing and the rotor, wherein the first bushing includes an radial wall extending radially from the third aperture, wherein the radial wall includes a channel forming a fourth communication passage configured to receive the portion of the first flow of fluid from the third communication passage.

5. The electric water pump of claim 3, wherein the second protrusion includes a wall that extends radially from the first aperture, wherein the wall includes a plurality of pockets extending radially from the first aperture.

6. The electric water pump of claim 5, wherein the second aperture is formed by a recessed portion of at least one of the plurality of pockets.

7. The electric water pump of claim 6, wherein at least one of the plurality of pockets is tapered.

8. The electric water pump of claim 7, wherein at least one of the plurality of pockets has an outer portion and an inner portion, wherein the inner portion has a first width and the outer portion has a second width, wherein the second width is greater than the first width.

9. The electric water pump of claim 2, further comprising a circuit board and an end cap extending between second portions of the sidewall, wherein the base member is a heat sink configured absorb heat from the circuit board.

10. An electric water pump for use in a vehicle, the electric water pump comprising:
a volute provided with a suction side, configured to receive a first flow of fluid, and a pressure side configured to expel a second flow of fluid;
an impeller configured to generate move the first flow of fluid and the second flow of fluid;
a sidewall coupled to the volute;
a cover extending from the sidewall and fixed to the volute, wherein the cover and the sidewall form a container;
a rotor disposed in the container;
a stator circumferentially surrounding the rotor, wherein the rotor and the stator form a first communication passage configured to communicate a portion of the first flow of fluid from a first space, disposed between the impeller and the cover;
a shaft fixed to the rotor and the impeller; and
a heat sink extending between portions of the sidewall and including a main portion and a first protrusion extending from the main portion towards the impeller, wherein the first protrusion defines a first receptacle, a second receptacle, and a first aperture, wherein the first receptacle receives a portion of the shaft, and wherein the first aperture extends radially between the first receptacle and the second receptacle and forms a second communication passage configured to receive the portion of the first flow of fluid from the first communication passage.

11. The electric water pump of claim 10, wherein the shaft is hollow and forms a third communication passage configured to receive the portion of the first flow of fluid from the first receptacle to the impeller.

12. The electric water pump of claim 10, wherein the second receptacle extends from an inner periphery of the first receptacle and terminates at an outer periphery of the protrusion.

13. The electric water pump of claim 11, wherein the second receptacle includes an outer portion and an inner portion wherein the inner portion has a first width and the outer portion has a second width, wherein the second width is greater than the inner portion.

14. The electric water pump of claim 11, further comprising a first bushing disposed in the first receptacle and including a second aperture, wherein the second aperture receives the shaft, wherein an inner periphery of the second aperture and an outer periphery of the hollow shaft forms a fourth communication passage configured to receive the portion of the first flow of fluid from the first communication passage.

15. The electric water pump of claim 9, further comprising a second bushing disposed on a first side of the rotor between the shaft and the cover, wherein the first bushing is disposed on a second side of the rotor, opposite of the first side of the rotor, wherein the rotor includes a stack of laminations, a first ring fixed to a first end of the stack of laminations, and a sleeve, wherein a first end of the sleeve, disposed on the first side of the rotor, is bent over the first ring and forms a first radius, wherein the first radius is configured to deflect the portion of the first flow of fluid from the first space.

16. The electric water pump of claim 15, further comprising an inner seal and an outer seal, wherein the inner seal is disposed between the hollow shaft and the first ring, and wherein the outer seal is disposed between the first ring and the sleeve.

17. The electric water pump of claim 16, further comprising a second ring fixed to a second end of the stack of laminations wherein a second end of the sleeve is bent over the second ring and forms a second radius, wherein the second radius is configured to deflect the portion of the first flow of fluid from the second communication passage to the heat sink.

18. The electric water pump of claim 17, wherein the second radius is formed by a bulbous section of the second end of the sleeve, wherein the bulbous section is spaced apart from a corner of the second end of the stack of laminations and is configured to deflect the portion of the first flow of fluid from the first communication passage to the heat sink.

19. An electric water pump for use in a vehicle, the electric water pump comprising:
a volute provided with a suction side, configured to receive a first flow of fluid, and a pressure side configured to expel a second flow of fluid;
an impeller configured to generate move the first flow of fluid and the second flow of fluid;
a sidewall coupled to the volute;
a cover extending from the sidewall and fixed to the volute and forming a container, wherein the cover includes a main portion, a first protrusion, extending from a first side of the main portion towards the impeller, and a second protrusion extending from a second side of the main portion, opposite the first side, wherein the first and second protrusions define a first aperture, wherein the second protrusion defines a second aperture forming a first communication passage configured to receive a portion of the first flow of fluid from a first space, disposed between the impeller and the cover;
a rotor disposed in the container;
a hollow shaft fixed to the rotor and the impeller, wherein the hollow shaft includes a first portion disposed within the first aperture;
a stator circumferentially surrounding the rotor, wherein the rotor and the stator form a second communication passage configured to communicate a portion of the first flow of fluid from a first space, disposed between the impeller and the cover; and
a heat sink extending between portions of the sidewall and including a third protrusion extending towards the impeller, wherein the third protrusion defines a first receptacle, a second receptacle, and a third aperture, wherein the first receptacle receives a second portion of the shaft, and wherein the second aperture extends radially between the first receptacle and the second receptacle and forms a third communication passage configured to receive the portion of the first flow of fluid from the second communication passage.

20. The electric water pump of claim 19, wherein the impeller and the cover form a low-pressure area and a high-pressure area, wherein as the impeller rotates the first flow of fluid is disposed in the low-pressure area and the second flow of fluid is disposed in the high-pressure area, wherein the first space is formed by the low-pressure area.
